(19) United States
(12) Patent Application Publication
(10) Pub. No.: US 2008/0306848 A1
(43) Pub. Date: Dec. 11, 2008

(54) Lead Generation Platform

(75) Inventors: Michael Ralph Bartholomew, Charlotte, NC (US); William Craig Etheredge, Ponte Vedra Beach, FL (US); Karen Pendleton, Charlotte, NC (US); Steffanie R. Gaus, Jacksonville, FL (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA CORPORATION, Charlotte, NC (US)

(21) Appl. No.: 11/758,298

(22) Filed: Jun. 5, 2007

(51) Int. Cl. G06Q 40/00

(52) U.S. Cl. 705/35

(57) ABSTRACT

A method and system is disclosed for a financial institution to offer one or more financial products or services to a customer. Upon receiving a triggering event, such as a customer transaction, at least one of an internal and external database concerning is queried, and an algorithmic determination of an optimum selection of financial products to be offered to the customer is executed. The initiated financial transaction may be executed simultaneously with the determination of an optimum selection of financial products. The optimum selection of financial products and services may be offered by the financial institution employee who is also processing the customer transaction.

### FIELD OF TECHNOLOGY

Aspects of the disclosure relate to initiating and optimizing lead generation. More specifically, aspects of the disclosure relate to offer-management tools to match customers and offers, alignment of offers to market opportunities, and determining customer preferences so as to develop and optimize customer relationships.

### BACKGROUND

Financial institutions provide a variety of financial products and services. Such financial products include consumer and small business products. The services may include the offering of loans (vehicle and home equity), lines of credit, mortgages, credit cards, debit cards, saving and checking accounts, retirement accounts, unsecured credit lines, insurance products, and a host of additional merchant services. As may be seen by the numerous products and services offered the operation of a financial institution has become both increasingly sophisticated and competitive.

Because of the number of different product/service offering and various customers' needs, it is difficult to match an individual customer's need with the current product and service offerings of the financial institution. Thus, individual customers may not be offered the best fit products or services based on their current needs. Currently, when a potential customer or existing customer inquires regarding an offered product or service a process begins in which the customer is referred to a product specialist in order to set up an appointment or call back.

A teller or financial institution employee receiving the initial contact may fill out a multi-part form which includes contact and personal identification information regarding the potential or existing customer and the specific inquiry or information request. A portion of the multi-part form may be routed to a personal banker or product specialist for handling. The use of paper forms with customer information imprinted thereon is cumbersome and may produce privacy concerns due to paper handling and routing.

In addition, the current process is inefficient as it delays receipt of information by the potential or existing customer which in turn delays sales opportunities. Moreover, a personal banker or other sale associate must contact the potential or existing customer only to have the customer potentially once again explain what products or services they have an interest in purchasing. Furthermore, a potential customer or existing customer may have to be contacted by additional financial institution employees to discuss additional products of interest based on the customer's responses to the interview. In addition, further follow-up may be required if a product or service is purchased to obtain any necessary signatures to meet any and all regulatory requirements.

Finally, the use of forms does not allow for efficient referral prioritization based on customer relationships and leads to inefficient tracking and reporting of customer contacts. Inefficient tracking does not allow the financial institution to properly measure customer interest in various offered products or services based on the number of customer inquires.

Generally, some of the embodiments of the invention are designed to address the foregoing and to provide a method or a system for a financial institution to generate, track, and fulfill customers leads while also improving the relationships with existing customers.

### BRIEF SUMMARY

The following presents a simplified summary of the disclosure in order to provide a basic understanding of some aspects of the invention. It is not intended to identify key or critical elements of the invention or to delineate the scope of the invention. The following summary merely presents some concepts of the disclosure in a simplified form as a prelude to the more detailed description provided below.

In an aspect of the invention, a method for a financial institution to offer one or more financial products or services to a customer is disclosed. In certain embodiments, generally the financial products or services may be selected from among a plurality of financial products or services offered by the financial institution. A triggering event is received and upon receipt of the triggering event, a database is queried. The database may be an internal database, an external database, or both, and in some embodiments multiple such databases are queried. The databases are queried for information concerning the customer. Upon receipt of the information, an algorithmic determination is made as to an optimum selection of financial products or services to be offered to the customer. The offers may be prioritized for financial institution employees.

In another aspect of the invention, the triggering event may be a customer inquiry or customer transaction. The initiated customer inquiry or transaction may be executed simultaneously with the determination of an optimum selection of financial products.

The optimum selection of financial products, utilization offer, or services may be presented to a customer and electronically fulfilled. In another embodiment, the accepted products or services are automatically routed for follow-up by a personal banker or processing by back office

When in the form of a system, the invention may comprise a computing device having a computer readable medium with code for receiving a triggering event, code for causing querying of databases, and code for causing algorithmic determination of an optimum selection of financial products or services to be offered to the customer. In some embodiments and aspects of the invention, the customer may be presented with a potentially beneficial product choice without having requested that category of product.

### BRIEF DESCRIPTION OF THE DRAWINGS

The present disclosure is illustrated by way of example and not limited in the accompanying figures in which like reference numerals indicate similar elements and in which:

FIG. 1 illustrates a schematic diagram of a general-purpose computing environment in accordance with certain aspects of the invention.

FIG. 2 depicts an illustration of new or existing customer interacting with a financial institution employee in accordance with various aspects of the invention.

FIG. 3 illustrates a flowchart depicting a method of offer management, utilization campaign, referral, and sales/fulfillment in accordance with at least one aspect of the invention.

FIGS. 4-8 illustrate process flow diagrams in accordance with various aspects of the invention.

### DETAILED DESCRIPTION

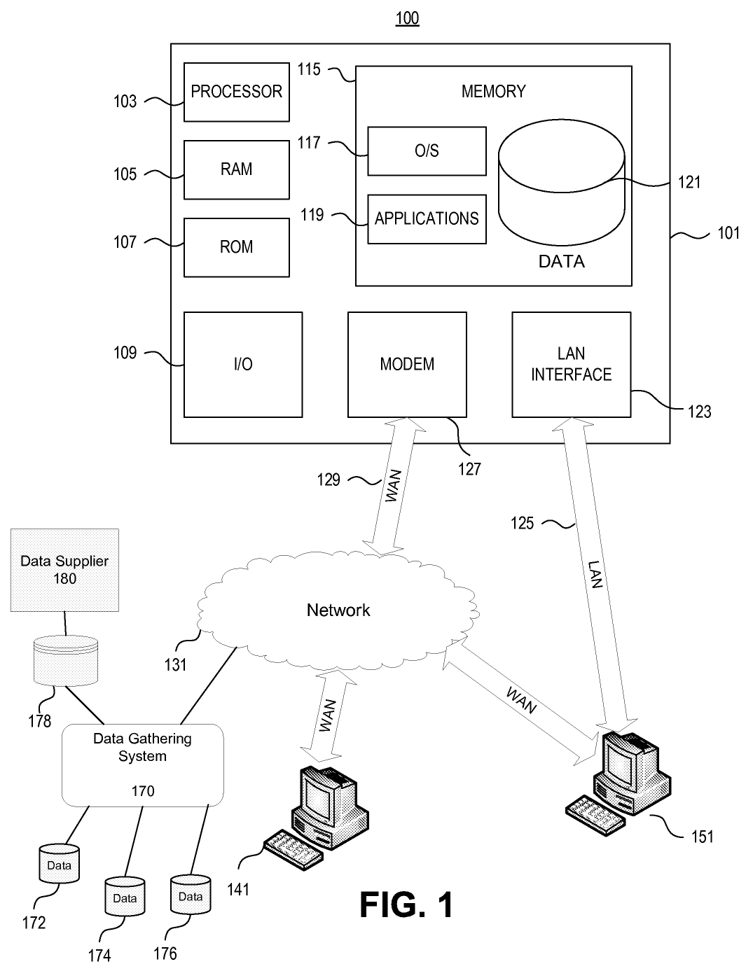

FIG. 1 illustrates an example of a suitable computing system environment 100 that may be used according to one or more illustrative embodiments of the invention. The computing system environment 100 is only one example of a suitable computing environment and is not intended to suggest any limitation as to the scope of use or functionality of the invention. The computing system environment 100 should not be interpreted as having any dependency or requirement relating to any one or combination of components illustrated in the exemplary computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, input/output module 109, and memory 115. Computer 101 typically includes a variety of computer readable media. Computer readable media may be any available media that may be accessed by computer 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 101.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. Although not shown, RAM 105 may include one or more are applications representing the application data stored in RAM memory 105 while the computer is on and corresponding software applications (e.g., software tasks), are running on the computer 101.

Input/output module 109 may include a microphone, keypad, touch screen, and/or stylus through which a user of computer 101 may provide input, and may also include one or more of a speaker for providing audio output and a video display device for providing textual, audiovisual and/or graphical output. Software may be stored within memory 115 and/or storage to provide instructions to processor 103 for enabling computer 101 to perform various functions. For example, memory 115 may store software used by the computer 101, such as an operating system 117, application programs 119, and an associated database 121. Alternatively, some or all of the computer executable instructions for computer 101 may be embodied in hardware or firmware (not shown). As described in detail below, the database 121 may provide centralized storage of account information and account holder information for the entire business, allowing interoperability between different elements of the business residing at different physical locations.

Computer 101 may operate in a networked environment supporting connections to one or more remote computers, such as terminals 141 and 151. The computers 141 and 151 may be personal computers or servers that include many or all of the elements described above relative to the computer 101. The network connections depicted in FIG. 1 include a local area network (LAN) 125 and a wide area network (WAN) 129, but may also include other wired and wireless networks. When used in a LAN networking environment, computer 101 is connected to the LAN 125 through a network interface or adapter 123. When used in a WAN networking environment, the server 101 may include a modem 127 or other means for establishing communications over the WAN 129, such as through network 131 which may be in an embodiment the Internet. It will be appreciated that the network connections shown are exemplary and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, at least one application program 119 used by the computer 101 according to an illustrative embodiment of the invention may include computer executable instructions for invoking user functionality related to communication, such as email, short message service (SMS), and voice input and speech recognition applications.

Terminals 141 or 151 may also be mobile terminals including various other components, such as a battery, speaker, and antennas (not shown). Input/output module 109 may include a user interface including such physical components as a voice interface, one or more arrow keys, joystick, data glove, mouse, roller ball, touch screen, or the like.

Information regarding customer accounts and/or external data may be obtained from a data gathering system 170. Data gathering system 170 may include a processor, memory and other conventional computer components and may be programmed with computer-executable instructions to communicate with other computer devices. Data gathering system 170 may access internal and/or external sources of information, such as information from internal sources 172, 174 and 176. The internal sources may include various database systems that provide customer transactional information and other information that may be used to determine customer preferences.

In addition, information may be supplied from numerous external data suppliers via an external data base 178. For instance, a data supplier 180 may include a private and/or federal or state agency that provides aggregate data and/or credit rating services information.

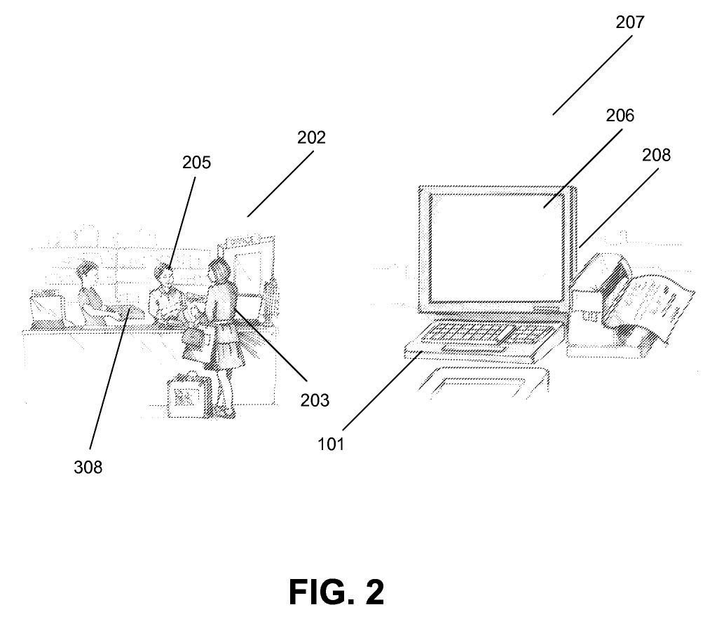

FIG. 2 illustrates an image 202 that depicts existing customer 203 requesting information regarding a product or service offered by a financial institution or conducting a particular transaction affecting an established account. Those skilled in the art will realize that the below exemplary embodiments discuss use of the invention in a financial institution but that the concepts of this invention may be used in numerous other places such as in call centers or other non-financial institutions. The use of a financial institution in the exemplary embodiments is not meant to be limiting but merely illustrative of the invention.

Furthermore, those skilled in the art will realize that a potential new customer may also be included in the below exemplary embodiments and that an existing customer is used below for illustrative purposes. A teller 205 receives the information request from an existing customer 203. The teller 205 inputs the requested information regarding the existing customer 203 into a user interface screen 206 as displayed on computer 102 as shown in image 207 of FIG. 2.

In an aspect of the invention, existing customer 203 may insert a financial institution card or other form of identification into a card reader which may enable the teller 205 to determine and authenticate the identification of existing customer 203. Other forms of customer identification that may be used to authenticate the customer may include the customer's name, address, social security number, contact information, income, a unique customer account identifier, and/or the like.

In an aspect of the invention, the process segments the offers displayed to a customer versus the offers that may be displayed to a small business for which a person represents. For example, a user may be both a personal customer of the financial institution and also an owner of small business whose accounts are also held and serviced by the financial institution.

In image 207 of FIG. 2, the user interface screen 206 shown on a display 208 of computer 102 may show information related to existing customer 203 regarding current accounts held by the customer 203 and their status. In an embodiment as the teller is completing the customer's transaction, additional information relating to products or services which may be of interest to the customer 203 may be provided to teller 205 on display 208 in order that such offers are communicated to the customer 203, if time permits. The process of generating appropriate offers and services to customer is explained in detail below.

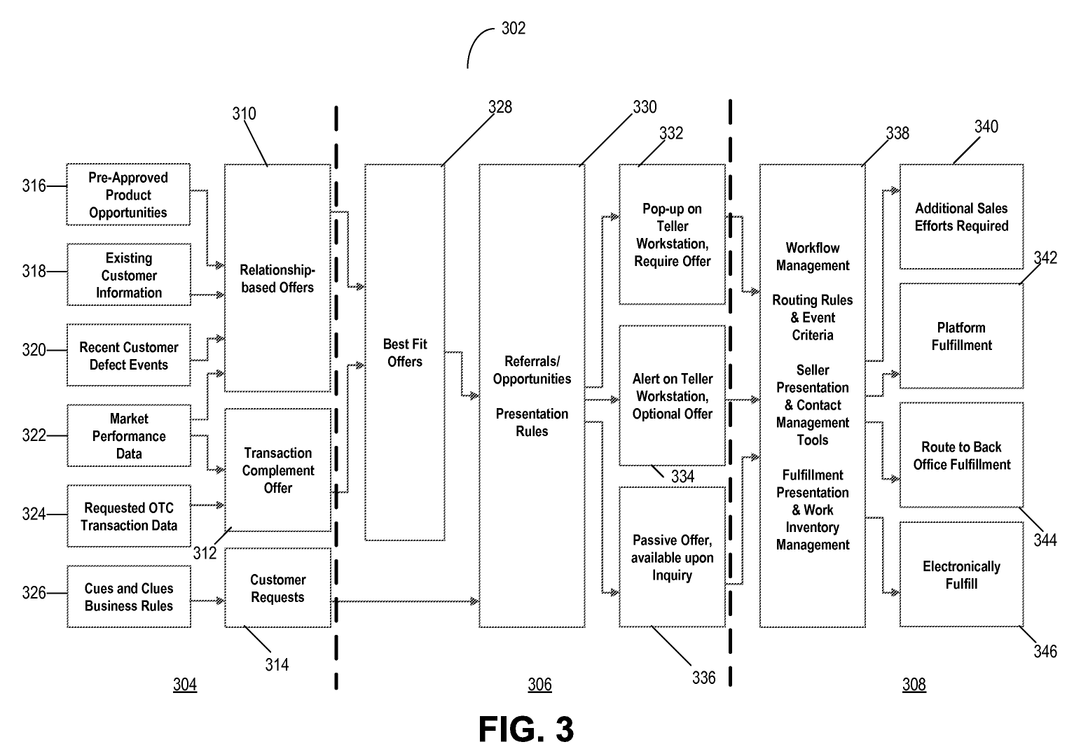

FIG. 3 illustrates a process diagram 302 in accordance with an aspect of the invention. The process diagram 302 may be divided into three main areas including offer management and product utilization offers 304, teller referral 306, and sales/fulfillment 308. Aspects of the invention may be described in the context of computer readable instructions, such as program modules, executed by one or more computers or devices. Generally, program modules include routines, programs, objects, components, and data structures etc. that perform particular tasks or implement particular abstract types. Typically the functionality of the program modules may be combined or distributed as desired in various embodiments. For example, modules may be logically divided among various files and/or processors. Furthermore, one or more of the modules may be optional and may be omitted in accordance with various embodiments of the invention.

The modules may receive various sources of data and utilize a rule based engine to calculate various offers to be extended to individual customers. For instance, the offer management area 304 may include the generation of offers such as relationship based offers 310, transaction complement offers 312, and offers based on customer requests 314.

In an aspect of the invention, the relationship based offers 310 may be generated based on information such as pre-approved product opportunities 316, existing customer information (which may include under-utilized products or services) 318, recent customer defect events 320, and market performance data 322. The pre-approved product opportunities 316 may be compiled from multiple sources and conditions and may be captured to proactively prepare offers for an individual customer upon customer interaction with a teller or other financial institution employee.

In an aspect of the invention, the existing customer information 318 may be supplied from internal databases that include information regarding a customer's account balances, transactional history, credit score, credit history, credit risk, number of offers extended to the customer, number of accounts maintained or previously maintained by the customer, customer delinquency, information regarding customer complaints, and the like. Sometimes, a financial institution may offer different programs or extend credit with differing terms (i.e. annual percentage rate, loan payment frequency, etc.) depending, in part, on a customer's credit and account information data. A customer's credit score may be obtained by an independent agency that performs statistical analysis of a customer's credit files. In an embodiment, utilization offers or enticements may be presented to a customer to encourage use of existing accounts with zero balances or inactivity.

Information included in the recent customer defect events 320 may include information regarding offers recently refused by the customer so that the same offers are not repeated within an adjustable period of time. In addition, offers pertaining to new introductory accounts for which a customer already has such an existing account may be screened so that a customer does not receive offers for which they do not qualify.

In an aspect of the invention, transaction complement offers 312 may be generated from data such as market performance data 322 and over-the-counter (OTC) transaction data 324. The OTC transaction data may provide information regarding immediate product offers or services that a customer may be eligible for opening or obtaining. For instance, a customer may be depositing a large sum of money into a non-interest bearing checking account. Based on existing customer information 318, the system may determine that the customer does not presently have any interest bearing savings accounts. The OTC transaction data 324 when realized by the system may generate a transaction complement offer 312 that may contain appropriate interest bearing savings accounts with current interest rates for customer consideration.

In another aspect of the invention, customer requests 314 may be inputted along with various business rules 326 and used to determine appropriate product selection or services to be offered to the customer. For example, a customer may request a higher interest rate on a saving account or checking account. In response, based on business rules and the products and services currently offered by the financial institution, a matching product or service may be offered to the customer. Another example may include an existing checking or credit card account which is under utilized. In response, based on business rules and the products and services currently offered by the financial institution, a more favorable set of terms, or conditions may be made to entice the customer to use that product or service.

In the teller referral area 306 of FIG. 3, multiple offers such as the relationship based offers 310 and transaction complement offers 312 may be prioritized and a single best fit offer 328 may be recommended to the teller in accordance with an embodiment of the invention. Those skilled in the art will realize that all of the generated offers are still available and those offers may be offered to the customer at later time or may be used for counter-offer purposes. Best fit offers may be presented to a teller in numerous ways and according to presentation rules 330 so that the offers may be presented at the appropriate time to the customer. For instance, in one aspect of the invention, a pop-up window 332 on the teller's computer may prompt a teller to initiate the offer. In another embodiment and according to presentation rules 330, a teller may be notified on their screen via an alert system 334 which notifies the teller about an offer that may be provided to the customer. The teller depending upon time restrictions for either the teller or the customer may determine that the offer should or should not be extended during a particular customer interaction.

In an additional embodiment, a teller may request that an offer be displayed based on information supplied by the requesting customer. For example, a customer may ask a teller whether they are eligible for a particular offer that their neighbor or other acquaintance may have received. In this particular embodiment, the teller may request that a passive offer 336 be displayed so that it may be presented to the customer.

In another aspect of the invention, a sales/fulfillment area 308 of the process diagram 302 may be executed in accordance with various embodiments of the invention. A rules engine 338 may be used to control and execute workflow management, initiate routing rules and event criteria, coordinate seller presentation and contact management tools, and/or to provide fulfillment presentation and work inventory management. In an embodiment, a customer may have additional questions and may have to be routed to a personal banker 340. In an alternative embodiment, a personal banker may fulfill the order 342 as no back office operations are needed. In another alternative embodiment, the information may have to be routed to a back office for fulfillment 344 due to regulatory concerns or to initiate a verification and approval process. Additionally, in another aspect of the invention, the offer may be electronically fulfilled 346 as no additional routing is required.

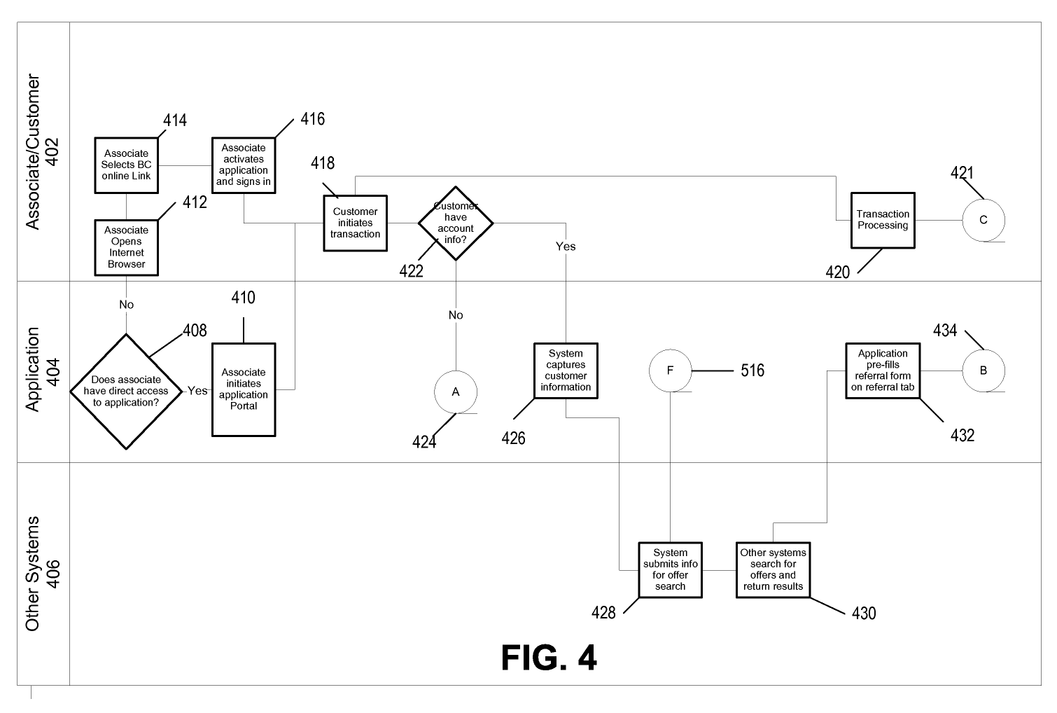

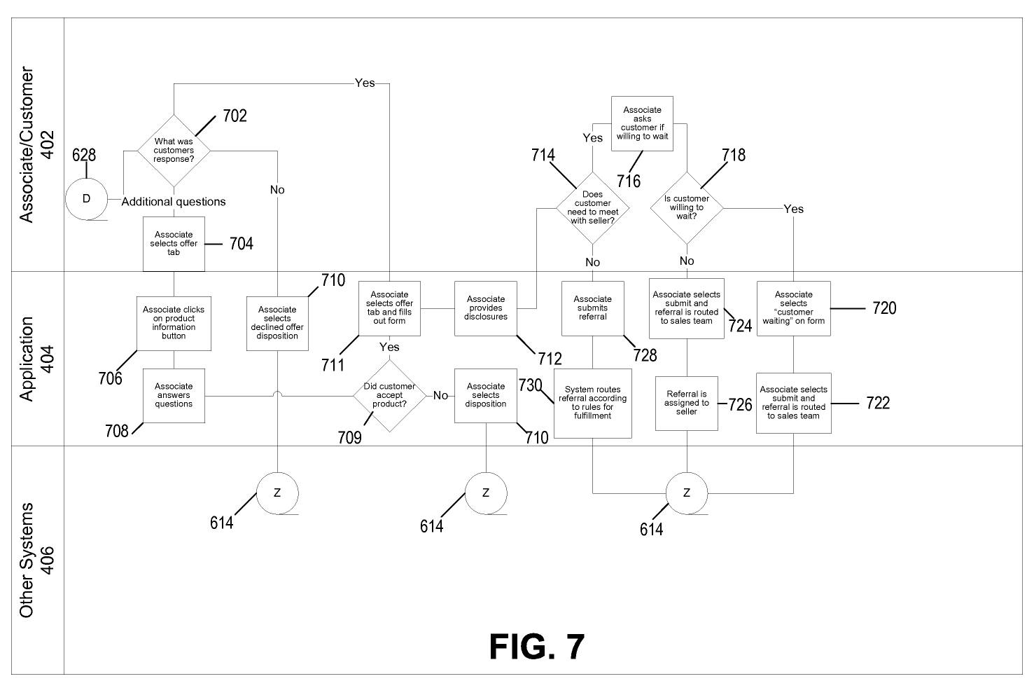

FIGS. 4-8 illustrate process flow diagrams which describe lead generation in accordance with various aspects of the invention. In FIGS. 4-8, the process flow diagrams illustrate actions executed by the employee/associate 402, actions executed by the lead generation application 404, and actions generated by other computer systems 406 supplying data. In at least one aspect of the invention, a triggering event may be any suitable event, such as the initiation of an inquiry by customer, the opening of an account, and an event activity that is not initiated by the customer, such as a periodic triggering event during a customer visit or financial institution employee request.

In FIG. 4, at step 408 the lead generation application may determine if an associate has direct access to the lead generation application. If the associate has direct access to the lead generation application, in step 410 an associate initiates an application portal. If the associate does not have access to the lead generation application, then in step 412 the associate may open a web browser and in step 414 select a link such as a “banking center” online link.

In step 416, the associate may activate the lead generation application and sign into the application using a user name and password. In step 418, an existing customer or new customer initiates a transaction with the associate. At the same time the transaction is being processed at step 420, the lead generation application may be processing to determine best fit offer scenarios that may be presented to the customer during completion of the initiating transaction. During transaction processing, the new or existing customer may not be aware that the lead generation application is extracting in the background. The lead generation application may determine potential offers that may be presented to the customer during or after completion of the initiating transaction.

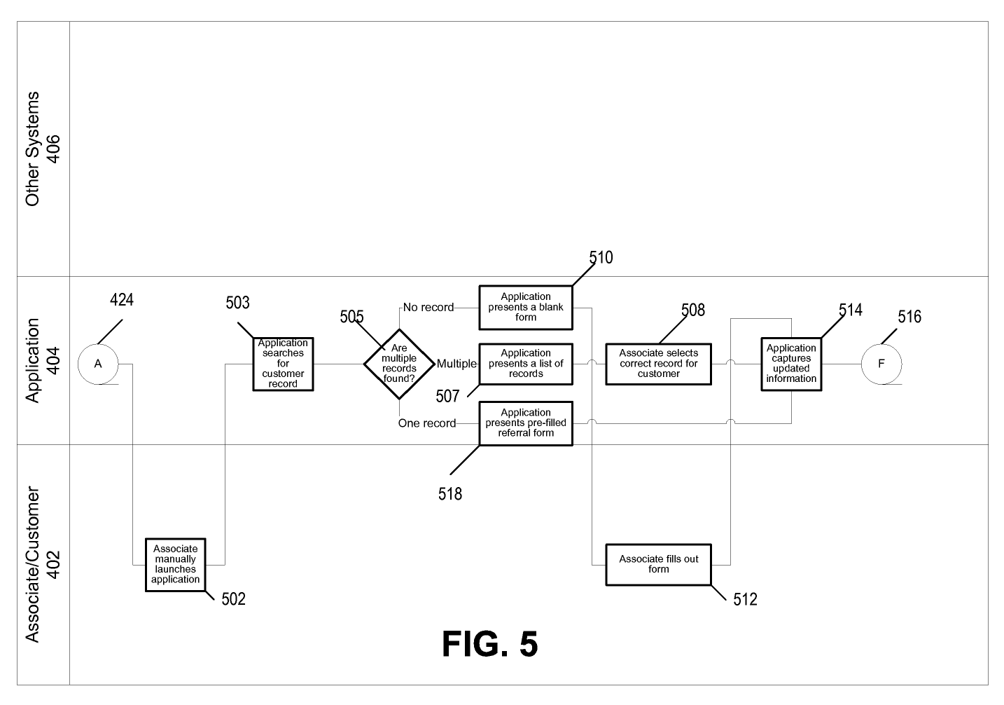

For instance, in step 422 it may be determined whether the customer initiating the transaction has an existing account or accounts with the financial institution. If it is determined that the customer is a potential new customer who does not have any accounts with the financial institution then the process continues at step 424 where the system allows the associate to create an information record regarding this potential new customer. In particular, in FIG. 5 at step 502 the associate may manually launch the application. The application at step 503 may continue to search for any existing customer records. At step 505, the lead generation application may determine if multiple records exist. For instance, multiple records may exist at step 507 if it is determined that more than one owner is listed on a particular account. If multiple records exist at step 507 then at step 508 the associate must select the correct customer record. For instance, a checking account may have both a husband and wife listed on a joint account. In this particular situation based on the account number, the lead generation application may locate multiple records, one for the husband and one for his wife. The associate would have to choose the correct record at step 508 based on the person with whom they are currently servicing.

If the lead generation application determines that there is no record for the customer then at step 510 the lead generation application provides a blank form which the associate may fill out at step 512. The information entered by the associate at step 512 may be captured by the lead generation program at step 514 with the process continuing at step 516. In an alternative embodiment, the lead generation application may at step 505 determine that only one record exists for the customer. In this embodiment, the lead generation program may present a pre-filled referral form to the associate at step 518 which may be verified and finalized by the associate.

Returning to FIG. 4 in step 422 it may be determined whether the customer initiating the transaction has an existing account or accounts with the financial institution. If it is determined that the customer is an existing customer then in step 426 the system captures the existing customer's information. In step 428 the system submits information to determine potential offers that may be presented to the existing customer. In step 430, other systems may also be searched for potential offers.

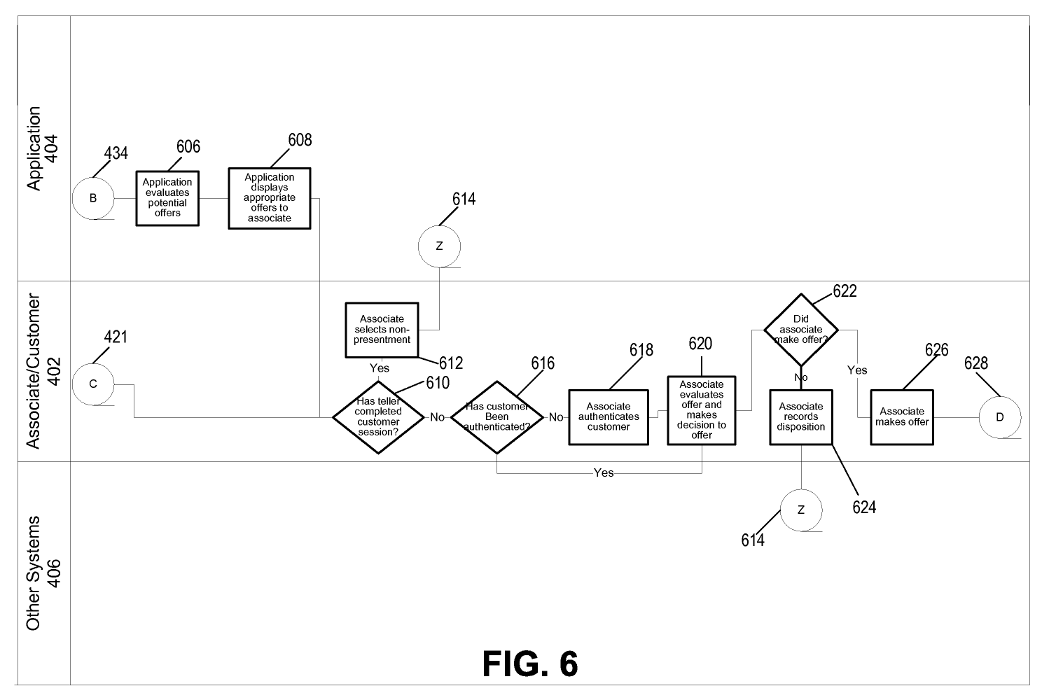

In accordance with an aspect of the invention, in step 432 the lead generation application may pre-fill a referral form which may be located on a referral tab displayed on the associate's computer or terminal. The process may continue at step 434 which is further illustrated of FIG. 6.

In FIG. 6 at step 606, the lead generation application may evaluate potential offers and determine the best fit offer from multiple offers. In step 608, appropriate offers may be displayed to the associate as the initial transaction in step 418 is still being completed. In one aspect of the invention, the offers displayed on one associate's computer screen may be different from the offers displayed on a different associate's computer screen for the same customer. The offers displayed to various associates may be tied to their specific knowledge base so that a newer associate is not attempting to explain a sophisticated product which they may not have yet become familiar with or have received at least some minimum level of training.

In step 610, a determination may be made as to whether an associate has completed their customer session. If the associate has completed their customer session then in step 612 the associate acknowledges that the offers were not presented to the customer. For example, the customer's initial transaction may have been completed before the offers were displayed or the customer did not have time during this particular transaction for presentation of the offers. If in step 610 the associate has not completed the customer transaction then in step 616 it may be determined if the customer has been authenticated. The authentication process of step 618 ensures that potential offers that may be presented by the associate are delivered only to customers whose identification has been verified.

In a further aspect of the invention, in step 620 the associate evaluates the offers displayed on their computer and determines which offers, if any, are to be presented to the customer. At step 622 a determination may be made as to whether the associate presented the offer or offers to the customer. In an embodiment, the associate may be required to enter information regarding whether or not the offer or offers were presented to the customer. If the offer was not presented to the customer then in step 624 the associate updates the record and the process continues at step 614. If it is determined that the associate made an offer to the customer at step 626 then the process continues at step 628.

In an aspect of the invention if at step 702 the customer requests additional information or has questions regarding the offered product or service then the associate at step 704 may select an offer tab screen on which additional product information may be found as illustrated at step 706. In step 708, the associate attempts to answer the customer's questions regarding the offer and/or product. When the customer's questions have been answered it is determined whether the customer has accepted the product or service offer in step 709. If the customer declines the offer then in step 710 the associate indicates such a response and the process continues at step 614. Subsequently, or otherwise, if the customer accepts the offer in step 709 then the associate in step 711 selects the offer tab and begins to fill out the product or service form for the accepted offer. Similarly, if in step 702, the customer accepts the offer the process continues to step 711.

In accordance with an aspect of the invention, in step 712 the associate provides the customer with appropriate disclosures based on the accepted product or service. In step 714 it may be determined if the customer wants to meet with a personal banker or other financial institution employee to discuss the accepted offer. If in step 714 it is determined that the customer wishes to discuss or meet with a personal banker then the customer is queried in step 716 as to whether they wish to wait to speak with the personal banker. In step 718, if the customer is willing to wait then in step 720 the associate selects the customer waiting form and the referral is routed to the sales team in step 722. If in step 718 it is determined that the customer is not able to wait to discuss the offered product with the personal banker then in step 724 the associate indicates such a response and the referral is routed to the sales team and a personal banker is assigned in step 726. The associate may ask the customer to indicate a preferred time to receive a call-back from the assigned personal banker.

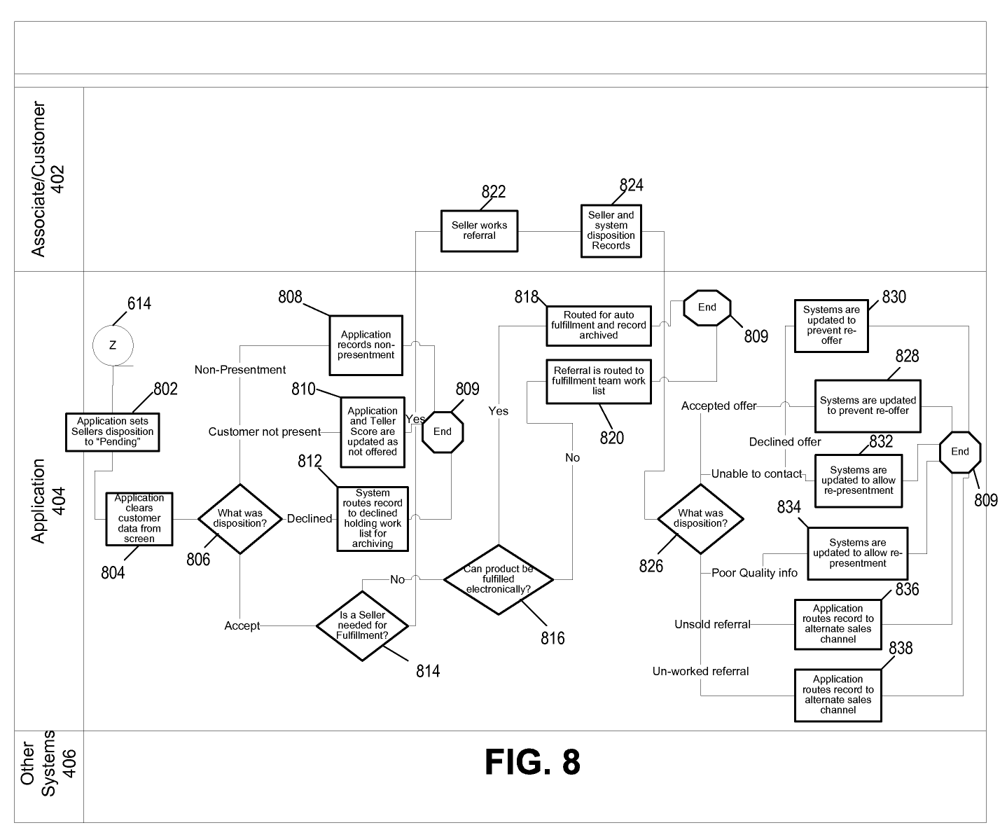

Returning back to step 714, if the customer does not want to meet with a personal banker then in step 728 the associate submits the referral and the system routes the referral according to fulfillment rules. If necessary, the system may route the referral to a back office for further processing. Next, the process continues at step 614 which is further illustrated in FIG. 8.

In FIG. 8, the lead generation application in step 802 may set the disposition to pending or undecided. In step 804, the application may clear the customer data from the computer screen. Next, in step 806 a determination may be made regarding the disposition of the presented offer. If the offer was not presented then in step 808 the lead generation application records the non-presentment outcome and the process ends at step 809. If it is determined through the authentication process that the customer himself or herself were not the ones making the initial transaction then in step 810 the lead generation application may update the record to reflect that the offer was not offered and the process ends at step 809. If the offer was declined by the customer then in step 812 the record is marked as declined and the disposition by the customer is stored and the process ends at step 809. Finally, if the customer accepts the offer then in step 814 a determination is made as to whether a personal banker is needed to fulfill the accepted offer.

If in step 814 a seller or personal banker is not needed for fulfillment then in step 816 a determination is made as to whether the accepted offer may be electronically fulfilled. If the accepted offer may be electronically fulfilled then in step 818 the order is routed for auto fulfillment and the record in archived. If the accepted offer can not be electronically fulfilled in step 816 then in step 820 the referral may be routed back to the fulfillment team. In either case, the process may end in step 809

Returning to step 814 if seller or personal banker is needed then in step 822 the personal banker may work the referral. In step 824, the personal banker may update the records disposition. Furthermore, in step 826 the lead generation application may make a determination as to the disposition of the offer. In an aspect of the invention, if the offer is accepted then in step 828 the system may be updated to prevent re-offers to the same customer. Similarly, if the offer is declined then in step 830 the system may be updated so as to prevent re-offers.

If the personal banker can not contact the customer for any reason then the system may be updated so as to allow the offer to be represented at another time as shown in step 832. Similarly, if the customer information can not be reached due to poor quality data then the system may be updated to allow the offer to be represented at another time as shown in step 834. Finally, if the record remains unsold or unworked the application may route the record to alternative sales channels as illustrated in steps 836 and 838.

Aspects of the invention have been described in terms of illustrative embodiments thereof Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure. Of course, the methods and systems of the above-referenced embodiments may also include other additional elements, steps, computer-executable instructions, or computer-readable data structures. In this regard, other embodiments are disclosed herein as well that can be partially or wholly implemented on a computer-readable medium, for example, by storing computer-executable instructions or modules, or by utilizing computer-readable data structures.

We claim:

1. A method for offering one or more financial products to a customer, the method comprising:
receiving a triggering event;
upon receipt of the triggering event, querying at least one internal database for information about the customer, the information being information that is useful in an algorithmic determination of a selection of financial products;
receiving the information based on the querying;
determining an optimum selection of financial products to be offered to the customer; and
displaying the optimum selection of financial products.

2. The method of claim 1, further including:
initiating a financial transaction based on the received triggering event, the initiated financial transaction executed simultaneously with the determination of an optimum selection of financial products.

3. The method of claim 1, wherein the triggering event received comprises a customer inquiry.

4. The method of claim 1, wherein the triggering event received comprises a teller input.

5. The method of claim 1, wherein the triggering event received comprises a customer transaction.

6. The method of claim 1, wherein the customer transaction, is initiated from at least one of a banking center, a kiosk, a call center session, an e-commerce session, an ATM session, a merchant service session, a dealer, and an affinity partnership service session.

7. The method of claim 21, further including:
offering the displayed optimum selection of financial products, services, and utilization enticements to the customer, the displayed optimum selection including separate segmentations of customer and small business products.

8. The method of claim 7, wherein the offered displayed optimum selection includes at least one a vehicle loan, a mortgage, a home equity line of credit, a checking account, a savings account, a credit card, a debit card, a retirement account, and an unsecured credit line.

9. The method of claim 1, wherein the information comprises recent customer defects.

10. The method of claim 1, wherein the information comprises previous financial products refused by the customer.

11. The method of claim 1, wherein both internal and external databases are queried.

12. A method for offering one or more products to a customer, the method comprising:
receiving a customer transaction;
upon receipt of the customer traction, querying at least one internal and external database for information about the customer, the information being information that is useful in an algorithmic determination of a selection of products;
determining an optimum selection of products to be offered to the customer based on at least in part the information;
executing the customer transaction simultaneously with the determination of the optimum selection of products; and
displaying the optimum selection of financial products.

13. The method of claim 12, wherein the customer transaction, is initiated from at least one of a banking center, a kiosk, a call center session, an e-commerce session, an ATM session, a merchant service session, and a dealer service session.

14. The method of claim 12, further including:
offering the displayed optimum selection of financial products to the customer.

15. The method of claim 14, wherein the offered displayed optimum selection includes at least one a vehicle loan, a mortgage, a home equity line of credit, a savings account, a credit card, a debit card, a retirement account, and an unsecured credit line.

16. The method of claim 12, wherein the information comprises recent customer defects.

17. The method of claim 12, wherein the information comprises previous financial products refused by the customer.

18. A computer-readable medium having computer-readable instructions for performing the steps of:
receiving a triggering event;
initiating a financial transaction based on the received triggering event;
querying at least one internal database for information about the customer, the information being information that is useful in an algorithmic determination of a selection of financial products based on the received trigger event;
receiving the information based on the querying;
determining an optimum selection of financial products to be offered to the customer;
displaying the optimum selection of financial products
wherein the initiated financial transaction is executed simultaneously with the determination of an optimum selection of financial products.

19. The computer-readable medium of claim 18, wherein the information comprises recent customer defects.

20. The computer-readable medium of claim 18, wherein the information comprises previous financial products refused by the customer.

21. The method of claim 1, wherein the step of determining an optimum selection of financial products further includes determining selection of optimum services or utilization enticements to be offered to the customer.
